(19) United States
(12) Patent Application Publication
(10) Pub. No.: US 2024/0346472 A1
(43) Pub. Date: Oct. 17, 2024

(54) SYSTEM AND METHOD FOR CALCULATING CONTRIBUTION ROOM FOR REGISTERED PLAN ACCOUNTS

(71) Applicant: The Toronto-Dominion Bank, Toronto (CA)

(72) Inventors: Breena Patricia GORMLEY, Toronto (CA); Anna KAPLUNOVICH, Toronto (CA)

(21) Appl. No.: 18/299,209

(22) Filed: Apr. 12, 2023

(51) Int. Cl. G06Q 20/10

(52) U.S. Cl. CPC G06Q 20/108

(57) ABSTRACT

Computing platforms, methods, and storage media for calculating contribution room for registered plan accounts are disclosed. Exemplary implementations may: obtain, from a registration organization device, initial contribution room data associated with funds eligible to be contributed into one or more registered plan accounts registered for a user with a registration organization; obtain, from one or more data sources, account contribution data associated with the user's one or more registered plan accounts; calculate, at a processor, an available contribution amount for the one or more registered plan accounts based on the initial contribution room data from the registration organization device and based on the account contribution data from the one or more data sources; and display the contribution room based on the calculated available contribution amount for the one or more registered plan accounts. Exemplary implementations consolidate data from disparate sources requiring authentication, and automate calculations based on the underlying data.

### FIELD

The present disclosure relates to account management, including but not limited to computing platforms, methods, and storage media for calculating contribution room for registered plan accounts.

### BACKGROUND

Registered plans, or registered investments, provide a helpful way for people to save and invest in registered accounts, which often include tax advantages. Each registered plan typically has an annual limit on the amount of funds that can be contributed, also referred to as “contribution room”. Contribution room calculations can often be complex, as they may be tied to a person's income. In some cases, contribution room can be carried over from one or more previous years.

While there are some known approaches that provide a mechanism for a user to enter contribution room and contribution amounts, there are currently no approaches to easily track available contribution room in more than one registered account.

Improvements in approaches for calculating contribution room for registered plan accounts are desirable.

### BRIEF DESCRIPTION OF THE DRAWINGS

Embodiments of the present disclosure will now be described, by way of example only, with reference to the attached Figures.

FIG. 1 illustrates a system configured for calculating contribution room for registered plan accounts, in accordance with one or more embodiments.

FIG. 2 illustrates another system configured for calculating contribution room for registered plan accounts, in accordance with one or more embodiments.

FIG. 3 illustrates a method for calculating contribution room for registered plan accounts, in accordance with one or more embodiments.

FIG. 4 illustrates a contribution room display for a first type of registered plan account, in accordance with one or more embodiments.

FIG. 5 illustrates a contribution room display for a second type of registered plan account, in accordance with one or more embodiments.

FIG. 6 illustrates a contribution room display for a third type of registered plan account, in accordance with one or more embodiments.

FIG. 7 illustrates a user interface for a user confirming authorization for open banking data sharing, in accordance with one or more embodiments.

FIG. 8 illustrates a user interface providing an overview of a plurality of registered plans including user-customized data, in accordance with one or more embodiments.

### DETAILED DESCRIPTION

Computing platforms, methods, and storage media for calculating contribution room for registered plan accounts are disclosed. Exemplary implementations may: obtain, from a registration organization device, initial contribution room data associated with funds eligible to be contributed into one or more registered plan accounts registered for a user with a registration organization; obtain, from one or more data sources, account contribution data associated with the user's one or more registered plan accounts; calculate, at a processor, an available contribution amount for the one or more registered plan accounts based on the initial contribution room data from the registration organization device and based on the account contribution data from the one or more data sources; and display the contribution room based on the calculated available contribution amount for the one or more registered plan accounts. Exemplary implementations consolidate data from disparate sources requiring authentication, and automate calculations based on the underlying data.

The present disclosure provides a system and method to automatically track, calculate and display, for example in real-time, available contribution room in one or more registered plan accounts, based on open banking data.

In one or more embodiments, a tool is provided for tracking and calculating available contribution room in one or more registered plan accounts (e.g., 401(k), IRA, RRSP, RESP, First Home Savings, etc.). Using open banking data, the system may obtain initial contribution room data from a government source (e.g., Internal Revenue Service, Canada Revenue Agency), and obtain account contribution data from one or more institutions with which the registered plan(s) is/are held. In one or more embodiments, available contribution room is calculated and displayed in real-time to a user, for example within an existing user account interface, so that the user does not need to log in to different accounts at different institutions. Since the process is automated and data may be provided in real-time, a user may have an accurate reflection of available contribution room, to assist in making self-service investment decisions.

One aspect of the present disclosure relates to a computing platform configured for calculating contribution room for registered plan accounts. The computing platform may include a non-transient computer-readable storage medium having executable instructions embodied thereon. The computing platform may include one or more hardware processors configured to execute the instructions. The processor(s) may execute the instructions to obtain, from a registration organization device, initial contribution room data associated with funds eligible to be contributed into one or more registered plan accounts registered for a user with a registration organization. The processor(s) may execute the instructions to obtain, from one or more data sources, account contribution data associated with the user's one or more registered plan accounts. The processor(s) may execute the instructions to calculate, at a processor, an available contribution amount for the one or more registered plan accounts based on the initial contribution room data from the registration organization device and based on the account contribution data from the one or more data sources. The processor(s) may execute the instructions to display the contribution room based on the calculated available contribution amount for the one or more registered plan accounts.

Another aspect of the present disclosure relates to a method for calculating contribution room for registered plan accounts. The method may include obtaining, from a registration organization device, initial contribution room data associated with funds eligible to be contributed into one or more registered plan accounts registered for a user with a registration organization. The method may include obtaining, from one or more data sources, account contribution data associated with the user's one or more registered plan accounts. The method may include calculating, at a processor, an available contribution amount for the one or more registered plan accounts based on the initial contribution room data from the registration organization device and based on the account contribution data from the one or more data sources. The method may include displaying the contribution room based on the calculated available contribution amount for the one or more registered plan accounts.

Yet another aspect of the present disclosure relates to a non-transient computer-readable storage medium having instructions embodied thereon, the instructions being executable by one or more processors to perform a method for calculating contribution room for registered plan accounts. The method may include obtaining, from a registration organization device, initial contribution room data associated with funds eligible to be contributed into one or more registered plan accounts registered for a user with a registration organization. The method may include obtaining, from one or more data sources, account contribution data associated with the user's one or more registered plan accounts. The method may include calculating, at a processor, an available contribution amount for the one or more registered plan accounts based on the initial contribution room data from the registration organization device and based on the account contribution data from the one or more data sources. The method may include displaying the contribution room based on the calculated available contribution amount for the one or more registered plan accounts.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

While there are some known approaches that provide a mechanism for a user to enter contribution room and contribution amounts, there are currently no approaches to easily track available contribution room in one or more registered accounts.

One technical problem is that up-to-date contribution room data is not easily made available. A registration organization may provide eligible or initial contribution room data at a time of a request. However, that initial contribution room data will not reflect any contributions or withdrawals made after the time of the request, since the registration organization is not made aware of such transactions, either at all or on a regular basis. Accordingly, the data available from a registration organization does not reflect currently available contribution room data, but rather eligible contribution room data at a time of a request.

Another technical problem is that a single data authority does not exist with respect to available contribution room data. A registration organization may be relied upon to provide initial contribution room data. An account data source may be relied upon to provide transaction data relating to deposits and withdrawals. However, the determination of actual available contribution room data is typically performed manually. For example, a user may obtain data from different sources, accounts and/or websites, using different authentication credentials for each one.

A further technical problem is that a user may have registered plan accounts with more than one institution. Each institution may have its own proprietary data format, and require unique login credentials to access transaction data relating to the registered plan account(s). Therefore, there is a technical problem of being able to securely access all of the necessary underlying data, and to do so in real-time, or near real-time, in order to provide helpful data to a user.

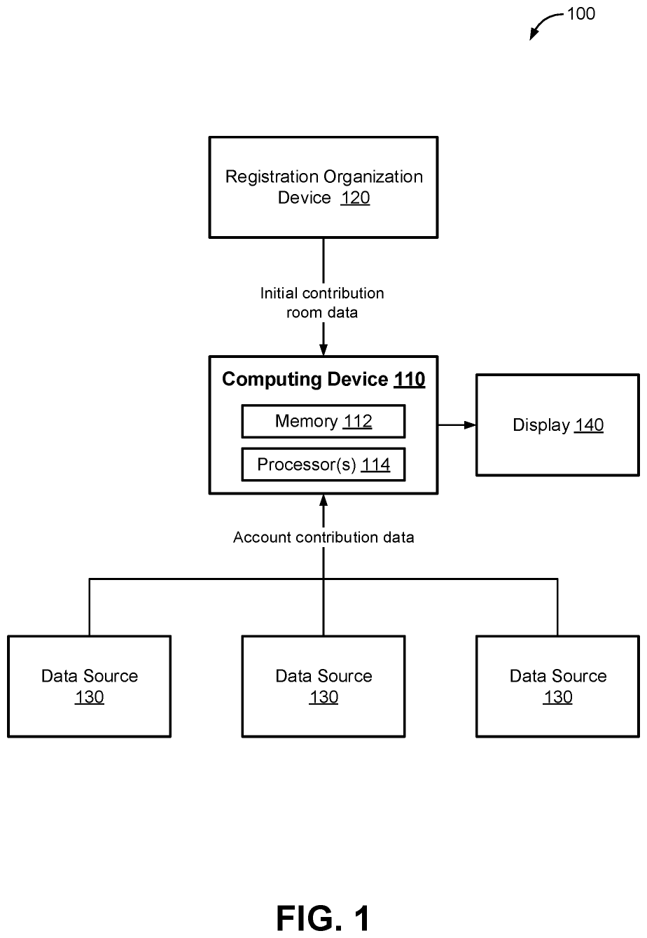

FIG. 1 illustrates a system 100 configured for calculating contribution room for registered plan accounts, in accordance with one or more embodiments. The system 100 comprises a computing device 110 in communication with a registration organization device 120. The registration organization device 120 is associated with a registration organization, such as a government organization providing registered plans. Examples of registration organizations include the Internal Revenue Service (IRS) in the United States, and the Canada Revenue Agency in Canada. The computing device is in communication with one or more data sources 130. The one or more data sources 130 may be associated with one or more institutions, for example a bank or other financial institution. The computing device 110 is also in communication with a display 140.

The computing device 110 may include a memory 112, such as a non-transient computer-readable storage medium having executable instructions embodied thereon. The computing device may include one or more hardware processors 114 configured to execute the instructions. The processor(s) may execute the instructions to obtain, from a registration organization device 120, initial contribution room data associated with funds eligible to be contributed into one or more registered plan accounts registered for a user with a registration organization. A registered plan may be a savings and/or investment account registered with a registration organization, such as a federal government, that offers tax advantages. Typically, a registered plan can hold a range of investment products. The one or more registered plan accounts may include a registered retirement savings plan (RRSP), a registered education savings plan (RESP), Tax Free Savings Account (TFSA), Registered Retirement Income Fund (RRIF), Registered Disability Savings Plan (RDSP), or first home savings plan (FHSP) in Canada. The one or more registered plan accounts may include an Individual Retirement Account (IRA) or 401(k) in the United States.

Initial contribution room data for a registered plan account is typically determined by a government organization, such as the Canada Revenue Agency in Canada. In some implementations, the initial contribution room data may include an initial contribution room amount and additional contribution room parameters. Some contribution room calculations may be straightforward, as the amount or number may be the same for almost all users. Other contribution room data may include more complex parameters or calculations. For example, for the calculation of contribution room for an RRSP account in Canada, the additional contribution parameters may include one or more of: the user's income; data relating to previous unused contribution room; and amounts of contributions in a current and previous years.

The computing device 110 may be configured to pull the initial contribution room data from the user's account on a government site. The computing device 110 may be configured to pull the initial contribution room data from the user's account on a government site in response to a notification of receipt of related correspondence from the registration organization. For example, the computing device 110 may be configured to pull the initial contribution room data in response to detecting receipt of an email or other notification indicating to the user that their Notice of Assessment has been published.

The processor(s) 114 may execute the instructions to obtain, from one or more data sources 130, account contribution data associated with the user's one or more registered plan accounts. The account contribution data may comprise transaction data, such as deposit data and withdrawal data. The deposit data and withdrawal data may include dates and amounts of deposits and withdrawals. In some implementations of the computing device, obtaining the account contribution data may include: obtaining, from a first data source, first account contribution data associated with a first registered plan account associated with a first institution; and obtaining, from a second data source, second account contribution data associated with a second registered plan account associated with a second institution. The first and second registered plan accounts may alternatively be associated with the same institution.

The processor(s) 114 may execute the instructions to calculate, at a processor, an available contribution amount for the one or more registered plan accounts based on the initial contribution room data from the registration organization device 120 and based on the account contribution data from the one or more data sources 130. In some implementations of the computing device, the processor(s) 114 may execute the instructions to calculate, automatically and in real-time, the available contribution amount based on the initial contribution room data from the registration organization and based on the account contribution data from the one or more data sources. The computing device 110 may be configured to pull the account contribution data from the one or more data sources. For the data to be accurate, the computing device 110 may refresh the data down to the minute, for example using real time rails.

The calculated available contribution amount may comprise a currently available contribution amount at a time associated with obtaining the initial contribution room data from the registration organization device and with obtaining the account contribution data from the one or more data sources. In some cases the initial contribution room amount may be consistent from one user to another, and in other cases they will differ, for example when the initial contribution room is based on a user's income.

With respect to calculating the available contribution amount, in most cases a user's contributions across institutions may vary, and withdrawals may vary. In addition, contributions and withdrawals will vary from user to user, whether at one institution or across more than one institution. Embodiments of the present disclosure provide a unique ability to track contribution room, contributions and withdrawals. In accordance with one or more embodiments, a real-time automated calculation of available contribution room is provided.

The calculation of the available contribution amount may vary depending on a type of registered plan account. One type of registered plan account is a retirement savings account. In an embodiment in which a registered plan account comprises an RRSP, the calculation of the available contribution amount may be based on an annual increase of allowable amount, which is relative to a user's income, as well as the defined cap on the amount for a given year. The system may be configured to examine a user's data to calculate the available contribution amount based on registered plan account parameters.

Another type of registered plan account is an education savings account. In an embodiment in which a registered plan account comprises an RESP, the calculation of the available contribution amount may also complicated, for example in a situation in which a joint RESP is set up for a number of children in the same family. While the funds may all be in a single account, contribution room may be assigned individually per child, and deposits are typically assigned to a particular child, or spread among all of the children, to determine available room. Also, because expenses may be high when children are young, families are often unable to make full use of all available room in a given year. Carry-over amounts may be difficult to calculate because of such details. There are often carry-over restrictions, such as being able to contribute a current year's amount and being able to carry over and additionally contribute the equivalent of only one previous year's amount per child. According to one or more embodiments, the computing device 110 may be configured to examine a user's account contribution data to determine individual available contribution room amounts for each of a plurality of children associated with the same RESP account.

In some implementations of the computing device 110, obtaining the account contribution data may further include obtaining, from a first data source, first account contribution data associated with a first registered plan account and with a first institution. In some implementations of the computing device, obtaining the account contribution data may further include obtaining, from a second data source, second account contribution data associated with a second registered plan account and with a second institution.

Using known approaches, a user may access a government site, sign in to a user account, and view the contribution room, for example from a Notice of Assessment. However, the indicated contribution room provided in such a scenario does not account for any contributions made that year; moreover, the government organization does not track any contributions from that day forward, resulting in an initial contribution room amount that is only valid as of the date that it is generated. Typically, a registration organization only calculates contribution room once per year and makes that calculation available to a user, for example via a dedicated correspondence or in the context of other account correspondence.

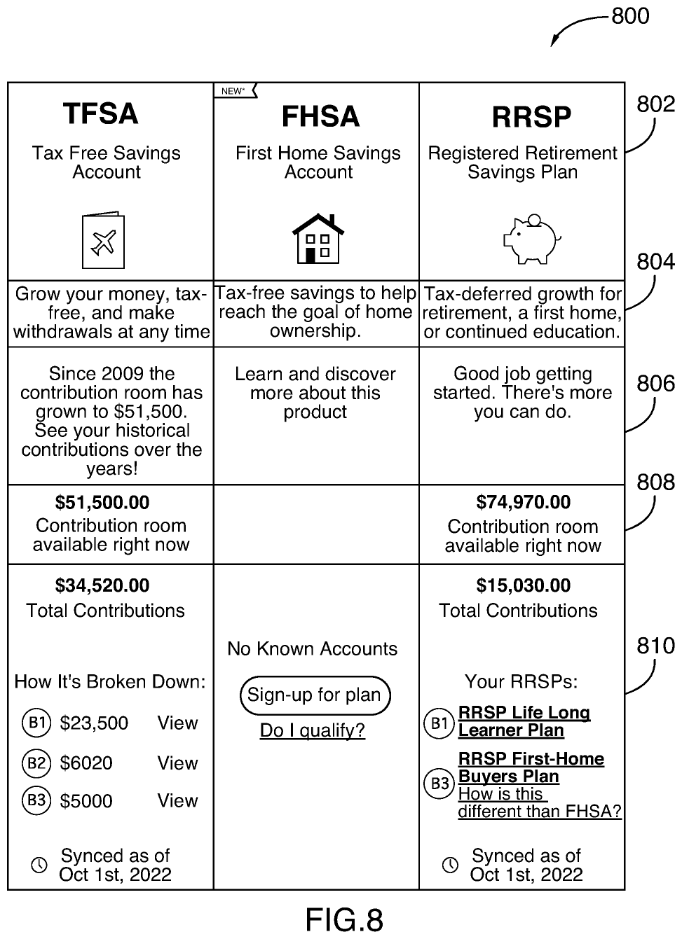

The processor(s) 114 may execute the instructions to display, for example in association with the display 140, the contribution room based on the calculated available contribution amount for the one or more registered plan accounts. The display 140 may be in communication with, associated with, or integral with the computing device 110. The computing device 110 may provide a running total in real-time of one or more registered plans including available room and contributions, as will be described later in relation to the output of FIG. 8.

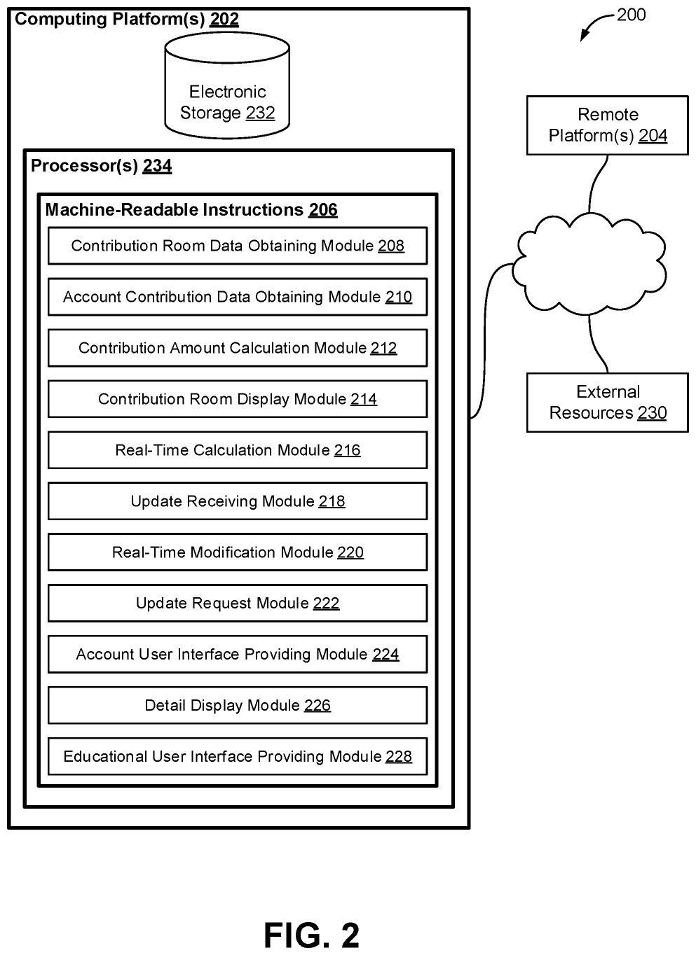

FIG. 2 illustrates a system 200 configured for calculating contribution room for registered plan accounts, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of contribution room data obtaining module 208, account contribution data obtaining module 210, contribution amount calculation module 212, contribution room display module 214, real-time calculation module 216, update receiving module 218, real-time modification module 220, update request module 222, account user interface providing module 224, detail display module 226, educational user interface providing module 228, and/or other instruction modules.

Contribution room data obtaining module 208 may be configured to obtain, from a registration organization device, initial contribution room data associated with funds eligible to be contributed into one or more registered plan accounts registered for a user with a registration organization. The initial contribution room data may include an initial contribution room amount and additional contribution room parameters. The registration organization may be a government organization.

Contribution room data obtaining module 208 may be configured to obtain the initial contribution room data from the registration organization using an open banking application programming interface. Open banking refers to a system by which different institutions (banks, financial institutions, government organizations) are encouraged or mandated to share data in an open manner, such that data from one organization may be used by another organization. Embodiments of the present disclosure leverage the data that may be shared using open banking to enable a system to automatically calculate and display a user's available contribution room in one or more registered plan accounts.

Account contribution data obtaining module 210 may be configured to obtain, from one or more data sources, account contribution data associated with the user's one or more registered plan accounts. Obtaining the account contribution data may further include obtaining, from a first data source, first account contribution data associated with a first registered plan account and second account contribution data associated with a second registered plan account. The first and second registered plan accounts may be both associated with a first type of registered plan account. The first registered plan account may be associated with a first type of registered plan account, and the second registered plan account may be associated with a second type of registered plan account.

Account contribution data obtaining module 210 may be configured to obtain the account contribution data associated with the user's one or more registered plan accounts from the one or more data sources using an open banking application programming interface. The initial contribution room data and the account contribution data may be both provided in an interoperable data format, such as a standard format for use with open banking. The one or more data sources may be associated with one or more institutions, such as financial institutions. The account contribution data may include deposit data and withdrawal data.

Contribution amount calculation module 212 may be configured to calculate, at a processor, an available contribution amount for the one or more registered plan accounts based on the initial contribution room data from the registration organization device and based on the account contribution data from the one or more data sources. Calculating the available contribution amount may further include calculating, at the processor, a first available contribution amount for the first type of registered plan account based on initial contribution room data from the registration organization device associated with the first type of registered plan account and based on the first account contribution data and on the second account contribution data.

Calculating the available contribution amount may further include calculating, at the processor, a first available contribution amount for the first type of registered plan account based on initial contribution room data from the registration organization device associated with the first type of registered plan account and based on the first account contribution data. Calculating the available contribution amount may further include calculating, at the processor, a second available contribution amount for the second type of registered plan account based on initial contribution room data from the registration organization device associated with the second type of registered plan account and based on the second account contribution data.

Calculating the available contribution amount may further include calculating, at the processor, a first available contribution amount for the first type of registered plan account based on initial contribution room data from the registration organization device associated with the first type of registered plan account and based on the first account contribution data and on the second account contribution data. Calculating the available contribution amount may further include calculating, at the processor, a second available contribution amount for the second type of registered plan account based on initial contribution room data from the registration organization device associated with the second type of registered plan account and based on the second account contribution data associated with the second institution.

Contribution room display module 214 may be configured to display the contribution room based on the calculated available contribution amount for the one or more registered plan accounts. Contribution room display module 214 may be configured to generate instructions to cause display of the contribution room based on the calculated available contribution amount for the one or more registered plan accounts. The calculated available contribution amount may include a currently available contribution amount at a time associated with obtaining the initial contribution room data from the registration organization device and with obtaining the account contribution data from the one or more data sources.

Real-time calculation module 216 may be configured to calculate, automatically and in real-time, the available contribution amount based on the initial contribution room data from the registration organization and based on the account contribution data from the one or more data sources. Real-time calculation module 216 may be configured to calculate and display, automatically and in real-time, the available contribution room for the one or more registered plan accounts. In some implementations, real-time calculation module 216 may communicate using an open banking application programming interface (API). The open banking API may include a push API, or a pull API.

Update receiving module 218 may be configured to regularly receive updates on the account contribution data via data push on a push API from the one or more data sources.

Real-time modification module 220 may be configured to modify, automatically and in real-time, a user interface including the displayed available contribution amount based on the regularly received updates on the account contribution data from the one or more data sources.

Update request module 222 may be configured to regularly request updates on the account contribution data via data query on a pull API to the one or more data sources.

Account user interface providing module 224 may be configured to provide, by a first institution, an account user interface including the contribution room. A selected account from among the one or more registered plan accounts may be associated with the first institution. For example, suppose a user has a first registered account with a first institution, and also has a number of other accounts with the same institution, accessible using a MyAccounts interface. The account user interface providing module may provide the MyAccounts interface so that it includes the contribution room for the selected registered plan account associated with the first institution.

Detail display module 226 may be configured to display additional details for the selected account associated with the first institution. In an example implementation, detail display module 226 may be configured to display additional details for the selected account associated with the first institution, and to provide the account user interface such that corresponding additional details are absent from the account user interface for registered plan accounts associated with a different institution.

Educational user interface providing module 228 may be configured to provide, by a first institution, an educational registered plan user interface including the contribution room. This may include, for example, a general educational page comparing different types of registered plan accounts. Such an educational page typically includes generic information. In accordance with one or more embodiments, the educational user interface providing module 228 may be configured to include the calculated contribution room as part of the educational user interface. Calculating the available contribution amount may further include calculating, at the processor, a first available contribution amount for the first type of registered plan account based on initial contribution room data from the registration organization device associated with the first type of registered plan account and based on the first account contribution data associated with the first institution. A selected account from among the one or more registered plan accounts may be associated with the first institution. The system may be configured to display additional details for the selected account associated with the first institution. The system may optionally provide the educational registered plan user interface such that corresponding additional details are absent from the educational registered plan user interface for registered plan accounts associated with a different institution.

In some implementations, the first and second registered plan accounts may be associated with a first data source and with a first institution. In some implementations, obtaining the account contribution data may further include obtaining, from a first data source, first account contribution data associated with a first registered plan account and with a first institution. In some implementations, obtaining the account contribution data may further include obtaining, from a second data source, second account contribution data associated with a second registered plan account and with a second institution. In some implementations, the first and second registered plan accounts may be both associated with a first type of registered plan account. In some implementations, the first registered plan account may be associated with a first type of registered plan account. In some implementations, the second registered plan account may be associated with a second type of registered plan account.

In some embodiments, computing platform(s) 202, remote platform(s) 204, and/or external resources 230 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 230 may be operatively linked via some other communication media.

A given remote platform 204 may include one or more processors configured to execute computer program modules. The computer program modules may be configured to enable an expert or user associated with the given remote platform 204 to interface with system 200 and/or external resources 230, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 230 may include sources of information outside of system 200, external entities participating with system 200, and/or other resources. In some embodiments, some or all of the functionality attributed herein to external resources 230 may be provided by resources included in system 200.

Computing platform(s) 202 may include electronic storage 232, one or more processors 234, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 232 may comprise non-transitory storage media that electronically stores information. The electronic storage media of electronic storage 232 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 232 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 232 may include one or more virtual storage resources (e.g., cloud storage, a virtual private network, and/or other virtual storage resources). Electronic storage 232 may store software algorithms, information determined by processor(s) 234, information received from computing platform(s) 202, information received from remote platform(s) 204, and/or other information that enables computing platform(s) 202 to function as described herein.

Processor(s) 234 may be configured to provide information processing capabilities in computing platform(s) 202. As such, processor(s) 234 may include one or more of a digital processor, an analog processor, a digital circuit designed to process information, an analog circuit designed to process information, a state machine, and/or other mechanisms for electronically processing information. Although processor(s) 234 is shown in FIG. 2 as a single entity, this is for illustrative purposes only. In some embodiments, processor(s) 234 may include a plurality of processing units. These processing units may be physically located within the same device, or processor(s) 234 may represent processing functionality of a plurality of devices operating in coordination. Processor(s) 234 may be configured to execute modules 208, 210, 212, 214, 216, 218, 220, 222, 224, 226, 228, 230, and/or 232, and/or other modules. Processor(s) 234 may be configured to execute modules 208, 210, 212, 214, 216, 218, 220, 222, 224, 226, 228, 230, and/or 232, and/or other modules by software; hardware; firmware; some combination of software, hardware, and/or firmware; and/or other mechanisms for configuring processing capabilities on processor(s) 234. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, 226, 228, 230, and/or 232 are illustrated in FIG. 2 as being implemented within a single processing unit, in embodiments in which processor(s) 234 includes multiple processing units, one or more of modules 208, 210, 212, 214, 216, 218, 220, 222, 224, 226, 228, 230, and/or 232 may be implemented remotely from the other modules. The description of the functionality provided by the different modules 208, 210, 212, 214, 216, 218, 220, 222, 224, 226, 228, 230, and/or 232 described below is for illustrative purposes, and is not intended to be limiting, as any of modules 208, 210, 212, 214, 216, 218, 220, 222, 224, 226, 228, 230, and/or 232 may provide more or less functionality than is described. For example, one or more of modules 208, 210, 212, 214, 216, 218, 220, 222, 224, 226, 228, 230, and/or 232 may be eliminated, and some or all of its functionality may be provided by other ones of modules 208, 210, 212, 214, 216, 218, 220, 222, 224, 226, 228, 230, and/or 232. As another example, processor(s) 234 may be configured to execute one or more additional modules that may perform some or all of the functionality attributed below to one of modules 208, 210, 212, 214, 216, 218, 220, 222, 224, 226, 228, 230, and/or 232.

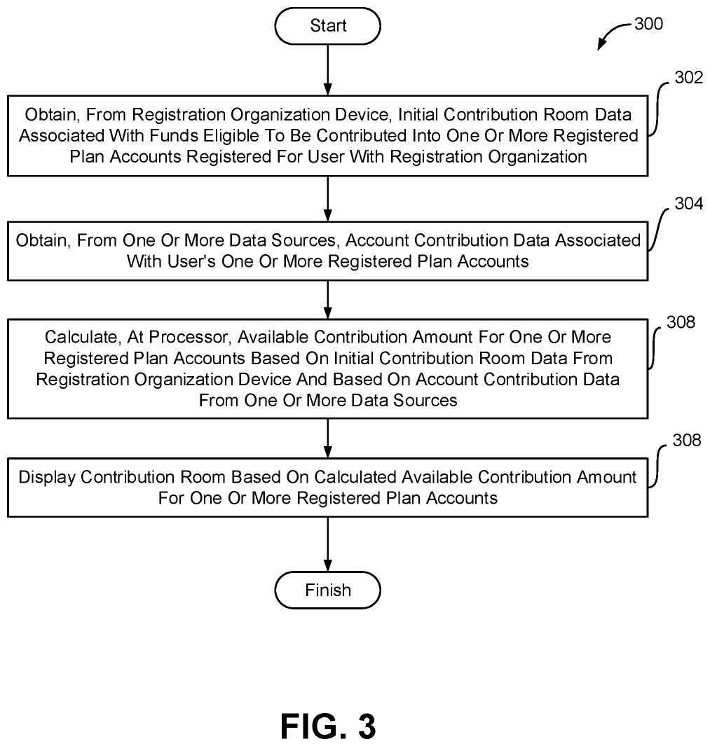

FIG. 3 illustrates a method 300 for calculating contribution room for registered plan accounts, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining, from a registration organization device, initial contribution room data associated with funds eligible to be contributed into one or more registered plan accounts registered for a user with a registration organization. Operation 302 may be performed by one or more hardware processors configured by machine-readable instructions including a module that is the same as or similar to contribution room data obtaining module 208, in accordance with one or more embodiments.

An operation 304 may include obtaining, from one or more data sources, account contribution data associated with the user's one or more registered plan accounts. Operation 304 may be performed by one or more hardware processors configured by machine-readable instructions including a module that is the same as or similar to account contribution data obtaining module 210, in accordance with one or more embodiments.

An operation 306 may include calculating, at a processor, an available contribution amount for the one or more registered plan accounts based on the initial contribution room data from the registration organization device and based on the account contribution data from the one or more data sources. Operation 306 may be performed by one or more hardware processors configured by machine-readable instructions including a module that is the same as or similar to contribution amount calculation module 212, in accordance with one or more embodiments.

An operation 308 may include displaying the contribution room based on the calculated available contribution amount for the one or more registered plan accounts. Operation 308 may be performed by one or more hardware processors configured by machine-readable instructions including a module that is the same as or similar to contribution room display module 214, in accordance with one or more embodiments.

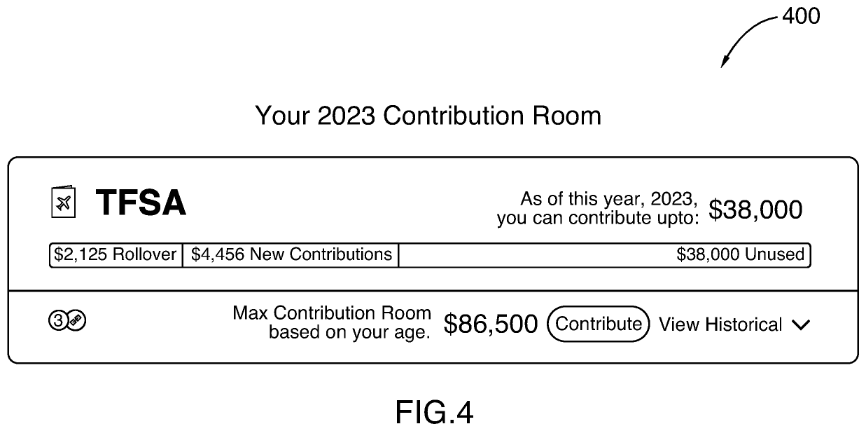

FIGS. 4-8 illustrate different user interfaces or contribution displays according to embodiments of the present disclosure. In some implementations of a computing device, processor(s) may execute the instructions to provide, by a first institution, an account user interface including the calculated contribution room. The account user interface may comprise, include or resemble the exemplary user interfaces in FIGS. 4-8. In some implementations of the computing device, a selected account from among the one or more registered plan accounts may be associated with the first institution. Available contribution room may be calculated and displayed in real-time to a user, for example within an existing account user interface, so that the user does not need to log in to different accounts at different institutions, if other registered plan accounts are held with different institutions.

While other known approaches may provide a display or calculation of contribution room, those known approaches are static and depend on manual user entry of relevant data. Moreover, such known approaches do not reflect account contribution data in the available contribution room, for example account contribution data from accounts held at a plurality of institutions. Embodiments of the present disclosure calculate and display available contribution room based on initial contribution room data, and based on account contribution data from one or more registered plan accounts associated with one or more institutions. When a plurality of registered plan accounts are associated with a plurality of institutions, the display of the available contribution room for the plurality of registered plan accounts may be performed in the context of an account user interface at a first institution associated with a selected registered plan account from among the plurality of registered plan accounts.

FIG. 4 illustrates a contribution room display 400 for a first type of registered plan account, in accordance with one or more embodiments. FIG. 4 illustrates a contribution room display for a registered savings account, such as a tax free savings account (TFSA), according to an implementation. The example of FIG. 4 illustrates a user's maximum available contribution room for the current year. In the example implementation of FIG. 4, the display indicates an amount of rollover contribution room of $2,125, for example from unused room from previous years. In the example implementation of FIG. 4, the display indicates an amount of new contributions of $4,456, along with the rollover contribution room, in the context of the total of $38,000 of unused TFSA contribution room. The example of FIG. 4 also shows the maximum contribution room based on a user's age, which in this case is $86,500.

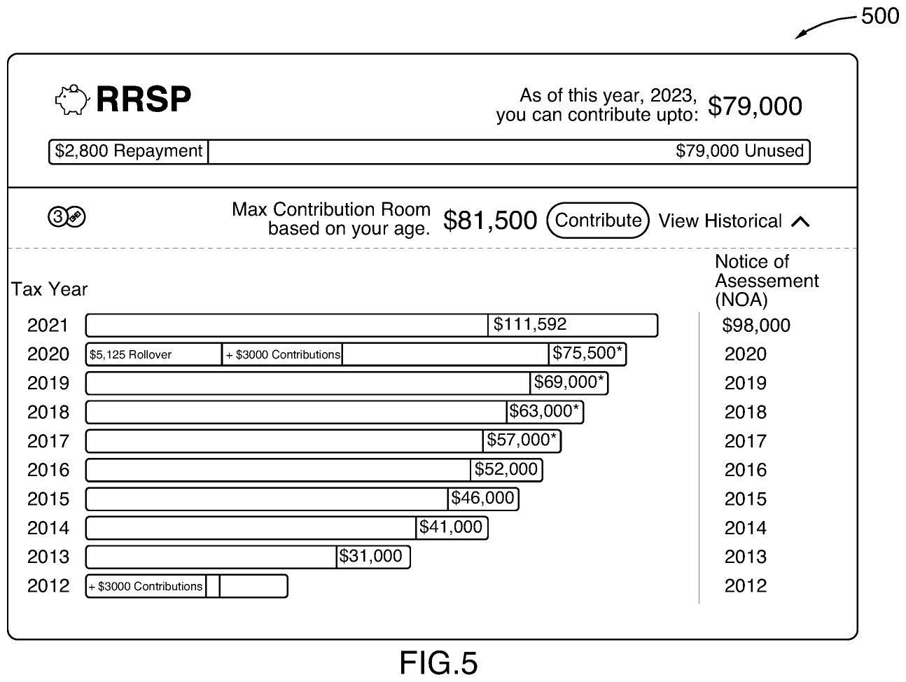

FIG. 5 illustrates a contribution room display 500 for a second type of registered plan account, in accordance with one or more embodiments. FIG. 5 illustrates a contribution room display for a retirement savings account, such as a registered retirement savings account (RRSP), according to an implementation. The example implementation of FIG. 5 shows that as of this year the user can contribution up to $79,000. The display of FIG. 5 also shows how a $2,800 repayment factors in to the $79,000 unused contribution room. The system may be configured to use data associated with the user's user of certain government benefits. For example, if the user has used the home buyer plan, the user would have to repay a certain amount, so that amount it taken into account when determining RRSP contribution room, as shown with the repayment amount in FIG. 5.

The example of FIG. 5 also shows the maximum contribution room based on a user's age, which in this case is $81,500. The example of FIG. 5 also shows different amounts by tax year, for example showing available contribution room, contributions made, and amounts of rollover. The example of FIG. 5 also shows how open banking data may be linked or incorporated in the contribution room display, for example by providing links to Notices of Assessment (NOAs) associated with a registration organization.

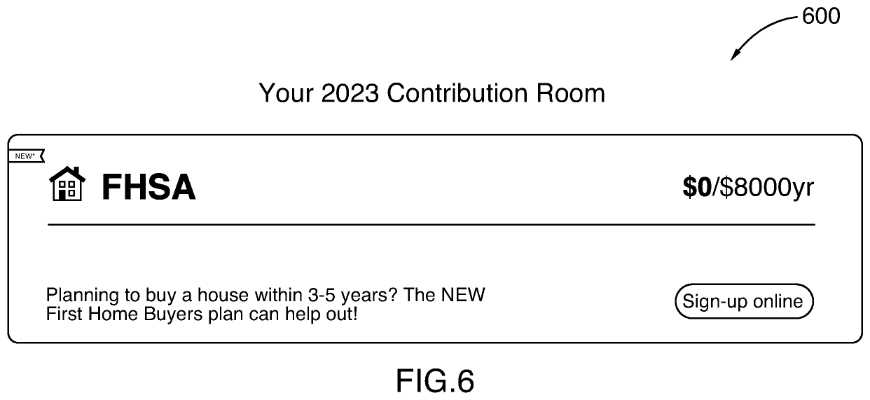

FIG. 6 illustrates a contribution room display 600 for a third type of registered plan account, in accordance with one or more embodiments. FIG. 6 illustrates a contribution room display for a first home buyers savings account according to an implementation. The example display 600 indicates an example for an unused type of registered plan. The unused plan may be characterized by the user not having made any contributions out of a possible $8,000 per year, but having opened an account. The unused plan may be characterized by the user not yet having opened or established an account of this type of registered plan. The contribution room display 600 may be beneficial in helping a user to familiarize themselves with other types of registered plans and their features and benefits, before opening such an account, or before making contributions to the account. The example of FIG. 6 also provides a button for the user to sign-up online for this particular type of account, for example with the financial institution that is providing the account interface.

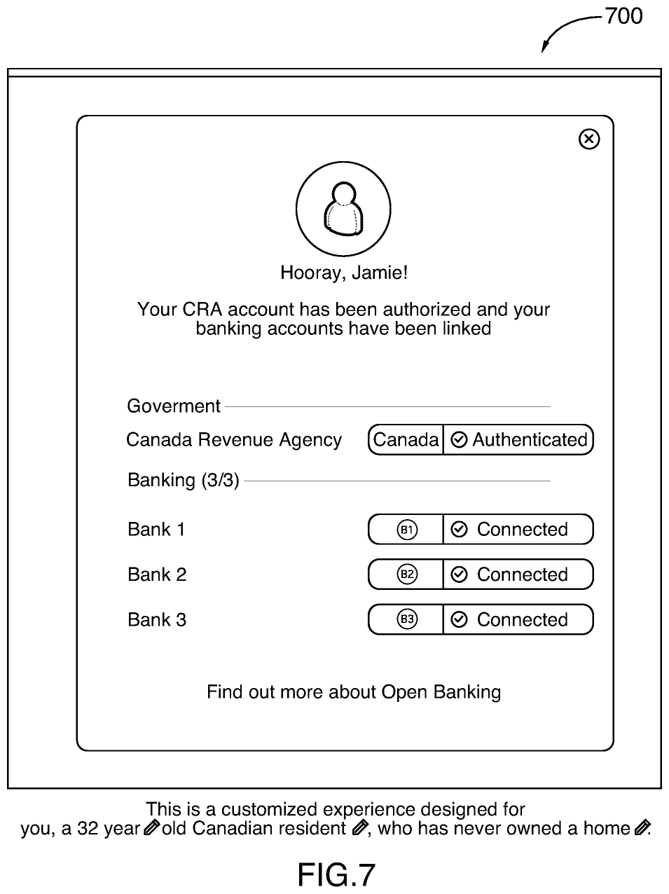

FIG. 7 illustrates a user interface 700, for example a welcome display, for confirming authorization for open banking data sharing, in accordance with one or more embodiments. In some implementations of a computing device, the initial contribution room data and the account contribution data may be both provided in an interoperable data format, for example a format compatible with open banking such as an open banking API. The example of FIG. 7 shows how a user interface can display or confirm linked accounts providing open banking data, which can be managed for the user. The user interface 700 may be provided in response to an earlier user interface providing the user with the ability to selectively link one or more registered plan accounts for open banking data sharing. Such open banking data sharing can facilitate obtaining the initial contribution room data from the registration organization device and obtaining the account contribution data from the one or more data sources.

The linking of the registered plan accounts may be facilitated via an account user interface provided by a financial institution associated with one of the registered plan accounts. In an implementation, the financial institution may create an API to package up account contribution data, and to share the account contribution data with an external party in response to a request for such data. The system may comprise backend security, and be configured to convert legacy software to overcome technical barriers to create APIs to share the data. Some current approaches may use screen scraping, link to a user's external accounts and see balances, but are unable to use data but rather data at a particular moment in time. Since the process is automated and data is preferably provided in real-time, a user may have an accurate reflection of available contribution room, for example leveraging open banking data and communication, to assist in making self-service investment decisions.

The user interface 700 shows a confirmation of accounts that are authorized and linked, such as a registration organization account with the Canada Revenue Agency, and banking accounts with different financial institutions, such as Bank 1, Bank 2 and Bank 3. The example of FIG. 7 may also show how the user interface is generated based on age, residency and homeowner status of the user, and provide a means to edit such parameters. For example, selection or actuation of a modification indicator, such as the pencil icons in FIG. 7, may enable the user to modify parameters associated with setting up a customized user experience, to prompt corresponding modifications in an underlying model or in the user interface display.

The user interface 700 of FIG. 7 relates to some implementations of a computing device, in which processor(s) may execute the instructions to obtain the initial contribution room data from the registration organization and/or the account contribution data associated with the user's one or more registered plan accounts using an open banking application programming interface. In some implementations of the computing device, the open banking API may include a push API. In some implementations of the computing device, the processor(s) may execute the instructions to regularly receive updates on the account contribution data via data push on the push API from the one or more data sources. In some implementations of the computing device, the processor(s) may execute the instructions to modify, automatically and in real-time, a user interface including the displayed available contribution amount based on the regularly received updates on the account contribution data from the one or more data sources. In some implementations of the computing device, the open banking API may include a pull API. In some implementations of the computing device, the processor(s) may execute the instructions to regularly request updates on the account contribution data via data query on the pull API to the one or more data sources.

FIG. 8 illustrates a user interface 800 providing an overview of a plurality of registered plans including user-customized data, in accordance with one or more embodiments. FIG. 8 illustrates a display for an overview of a plurality of registered plans including user-customized data according to an implementation, which may be implemented as part of an educational user interface. The educational interface may provide a combination of generic educational information and user-specific and account-specific information.

The user interface 800 may provide educational information, which is typically provided only on a generic basis on a public website, in a customized and contextual manner. For example, user-specific financial educational information may be provided when the user is logged in to an account, and the user interface 800 embeds information about the user. The embedded information may belong to more than just the institution providing the educational user interface, for example pulling data and insights from alternative data sources in an open banking environment.

Known approaches have not been able to implement such a system because of the lack of aggregate data across institutions. In accordance with one or more embodiments, the system brings in government, legal, other institutions, all provided as part of a user interface, for example in the context of education. While existing approaches can serve up an ad based on internal system, within the context of account management platform, embodiments of the present disclosure may use a user's open banking data in the context of educational content.

In some related implementations of a computing device, processor(s) may execute instructions to provide, by a first institution, the educational registered plan user interface 800 including the contribution room. In some implementations of the computing device, a selected account from among the one or more registered plan accounts may be associated with the first institution. Processor(s) may execute the instructions to display additional details for the selected account associated with the first institution. In some implementations of the computing device, the processor(s) may execute the instructions to where corresponding additional details are absent from the educational registered plan user interface for registered plan accounts associated with a different institution.

The user interface 800 may comprise a plurality of display components. In the example of FIG. 8, the plurality of display components is arranged in a plurality of rows, with each display component including content for a plurality of columns.

The user interface 800 of FIG. 8 comprises a first display component 802, for example in a top row of the user interface, providing a registered plan account type indicator. For example, the first display component 802 comprises three registered plan account type indicators: TFSA (Tax Free Savings Account), FHSA (First Home Savings Account) and RRSP (Registered Retirement Savings Plan).

The user interface 800 comprises a second display component 804, which may provide educational information associated with the corresponding registered plan account type. In the example of FIG. 8, the second display component 804 comprises a brief overview of the registered plan account type. In other embodiments, the second display component may comprise additional details and/or links to further information.

The user interface 800 comprises a third display component 806, which may provide user-specific data or narratives, for example taking into account user data or account data. In FIG. 8, the portion of the second display component 806 associated with the TFSA account type indicates the total amount of $51,500 to which the contribution room has grown since 2009. The same portion of the second display component 806 associated with the TFSA account type provides the ability to view historical contributions over the years, for example by actuating or clicking on the associated text. A portion of the display component 806 associated with the FHSA account type provides a generic statement to learn and discover more about this product, with optional ability to be directed to additional information when actuating or clicking on the associated text. A portion of the display component 806 associated with the RRSP account type provides a user-specific narrative based on the underlying data, without providing specific data. In this case, the narrative indicates that the user has done a good job getting started, and indicates there is more that the user can do. Selection of the user-specific narrative may be based on analysis of the available contribution amount, and on the account contribution data.

The user interface 800 comprises a fourth display component 808, which may provide an indication of an available contribution amount for each of a plurality of registered plan account types. In FIG. 8, the fourth display component 808 provides an available contribution amount of $51,500.00 for the user's tax free savings account(s). The available TFSA contribution amount may be calculated based on initial contribution room data and on account contribution data for each of a plurality of TFSA accounts.

In FIG. 8, the fourth display component 808 provides an available contribution amount of $74,970.00 for the user's registered retirement savings plan account(s). The available RRSP contribution amount may be calculated based on initial contribution room data and on account contribution data for each of a plurality of RRSP accounts, and optionally for each of a plurality of RRSP account sub-types such as individual RRSP and spousal RRSP. In FIG. 8, the fourth display component 808 is blank with respect to the FHSA account type, since the user does not currently have any accounts of this type, while the educational user interface provides an opportunity for the user to learn more about this type of account and encourages the user to open an account of this type.

In addition to the total available contribution amount for each registered plan type, the fourth display component 808 may additionally provide individual available contribution amounts for each of one or more accounts of each registered plan account type. For example, with respect to FIG. 8, the fourth display component 808 may additionally provide individual available contribution amounts, or indications of contribution room, for each of the three TFSA accounts listed.

For more than one account of the same type at the same bank, in some related implementations of a computing device, the first and second registered plan accounts may be both associated with a first type of registered plan account. In some implementations of the computing device, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

The example of FIG. 8 illustrates two different account types at the same bank, for example a first TFSA account (first type of registered plan account) at B1 (first institution) and an RRSP account (second type of registered plan account) at B1 (first institution). In some related implementations of a computing device, the first registered plan account with $23,500 in contributions may be associated with a first type of registered plan account (TFSA). In some implementations of the computing device, the second registered plan account RRSP Life Long Learner Plan may be associated with a second type of registered plan account (RRSP). In some implementations of the computing device, calculating the available contribution amount may further include calculating, at the processor, a first available contribution amount for the first type of registered plan account based on initial contribution room data from the registration organization device associated with the first type of registered plan account and based on the first account contribution data. In some implementations of the computing device, calculating the available contribution amount may further include calculating, at the processor, a second available contribution amount for the second type of registered plan account based on initial contribution room data from the registration organization device associated with the second type of registered plan account and based on the second account contribution data.

The example of FIG. 8 also illustrates two different account types at two different institutions, for example a TFSA account (first type of registered plan account) at B2 (first institution) and an RRSP account (second type of registered plan account) at B3 (second institution). In some related implementations of a computing device, the first registered plan account with $6,020 in contributions may be associated with a first type of registered plan account (TFSA). In some implementations of the computing device, the second registered plan account of the RRSP First-Home Buyers Plan may be associated with a second type of registered plan account (RRSP). In some implementations of the computing device, calculating the available contribution amount may further include calculating, at the processor, a first available contribution amount for the first type of registered plan account (TFSA) based on initial contribution room data from the registration organization device associated with the first type of registered plan account (TFSA) and based on the first account contribution data associated with the first institution B2. In some implementations of the computing device, calculating the available contribution amount may further include calculating, at the processor, a second available contribution amount for the second type of registered plan account based on initial contribution room data from the registration organization device associated with the second type of registered plan account (RRSP) and based on the second account contribution data associated with the second institution B3.

The user interface 800 comprises a fifth display component 810, which may provide an indication of total contribution amounts for each of a plurality of registered plan accounts and for each of a plurality of account types. The example of FIG. 8 shows a plurality of different types of registered accounts, for example using data from open banking to indicate what a user has at what organizations in relation to the plan type, and optionally indicate the plan benefits that the user has realized. The fifth display component 810 may comprise an indication of the date of last synchronization, for example as shown at the bottom of the TFSA and RRSP sections, to provide additional reassurance to the user of the reliability and currency of the data.

The fifth display component 810 for the TFSA account type includes three different accounts, one each at 3 different banks, indicated by B1, B2 and B3. The fifth display component 810 comprises a total contribution amount for the TFSA account type, as well as individual contribution amounts for each of the individual TFSA accounts. The fifth display component 810 may provide the ability to view additional details of each of the accounts of this TFSA type, even if they are at a different institution. The data may be synchronized across all institutions in terms of what a user has and where, and may display the dollar amount. Instead of just making an educational page, the system may synchronize a customer's actual data, and display it in context of a story, creating education plus contextual data/personalization. Such an implementation has not been possible before, because of the lack of aggregate data across institutions.

The fifth display component 810 for the FHSA account type indicates that there are no known accounts of this type for this user, for example based on open banking data queries. The fifth display component 810 for the FHSA account type provides the ability for a user to sign-up for a registered plan of this type, and may also provide the ability to link to a tool to help the user determine whether they qualify for this type of account.

The fifth display component 810 for the RRSP account type has two different accounts, one at each of two different banks B1 and B3. The fifth display component 810 comprises an indication of details associated with each of the accounts of the RRSP account type. This example shows that the fifth display component 810 may comprise user-specific and account-specific information, which in the case of the TFSA account type includes a breakdown of contribution amounts per account, and in the case of the RRSP account type includes details of the type or sub-type of RRSP account without specifying individual contribution amounts.

According to an implementation, a system is configured to synchronize all of the customer data (where they bank, what plans they have open, how much they have contributed in every calendar year) and view the actual contribution room for each account (not just asking a user to manually check with the registration organization for the actual amounts). The system may be configured to obtain initial contribution room data from one or more Notices of Assessment, as well as to obtain data associated with registered plan contributions across all institutions. The system may then be configured to determine a user's available contribution room, and for example determine amount of repayment for a first homebuyer plan benefit. The system does this in an automated way. A system of embodiments of the present disclosure may provide a consolidated accurate contribution room tracker based on, and optionally including, real-time data, which has not yet been done using known approaches.

Embodiments of the present disclosure provide a system and method to automatically track, calculate and display, preferably in real-time, available contribution room in one or more registered plan accounts, based on open banking data.

In one or more embodiments, a tool is provided for tracking and calculating available contribution room in one or more registered plan accounts (e.g. 401(k), IRA, RRSP, RESP, First Home Savings, etc.). Using open banking data, the system may obtain initial contribution room data from a registration organization device, such as a government source, and obtain account contribution data from one or more data sources associated with institutions with which the registered plan(s) is/are held. In one or more embodiments, available contribution room is calculated and displayed in real-time to a user, for example within an existing user account interface, so that the user does not need to log in to different accounts at different institutions. Since the process is automated and data is provided in real-time, a user can always have an accurate reflection of available contribution room, to assist in making self-service investment decisions.

As indicated earlier, one technical problem is that up-to-date contribution room data is not easily made available. A registration organization may provide eligible or initial contribution room data at a time of a request. However, that initial contribution room data will not reflect any contributions or withdrawals made after the time of the request, since the registration organization is not made aware of such transactions, either at all or on a regular basis. Accordingly, the data available from a registration organization does not reflect currently available contribution room data, but rather eligible contribution room data at a time of a request. Embodiments of the present disclosure provide a technical solution by combining, at a processor, initial contribution room data obtained from the registration organization with obtained account contribution data from one or more registered plan accounts. The obtained account contribution data may be obtained in real-time, for example using an open banking API, to generate up-to-date calculated contribution amounts.

Embodiments of the present disclosure may obtain, store and collect the initial contribution room data and the account contribution data in a common data format, for example according to an open banking standard or using an open banking API. The compilation of the initial contribution room data and regularly updated account contribution data for one or more registered plan accounts provides a technical solution to the technical problem caused by lack of interoperability of the data. Embodiments of the present disclosure provide a further technical solution of automatically generating calculations of available contribution amounts, where such calculations were not previously possible using known approaches because of lack of access to updated data, as well as technical limitations with respect to automatically calculating the contribution amounts when authenticated access may be required at a plurality of institutions to simply have access to the underlying data.

Another technical problem is that a single data authority does not exist with respect to available contribution room data. A registration organization may be relied upon to provide initial contribution room data. An account data source may be relied upon to provide transaction data relating to deposits and withdrawals. However, the determination of actual available contribution room data is typically performed manually. For example, a user may obtain data from different sources, accounts and/or websites, using different authentication credentials for each one. Embodiments of the present disclosure provide a technical solution by providing, for example at a computing device associated with a financial institution, a single data authority that obtains both initial contribution room data from the registration organization, as well as obtains account contribution data from one or more institutions relating to one or more registered plan accounts. The technical solution may comprise obtaining authenticated access, for example in real-time using an open banking API, to the initial contribution room data and the account contribution data from a plurality of institutions. The technical solution may also comprise storing these sets of data in a single database, or in one or more data servers associated with the same institution, so that a user's authenticated access to an account at a first institution provides authenticated access to all of the data required to calculate and display, preferably in real-time, the available contribution amount associated with each of one or more registered plan accounts.

A further technical problem is that a user may have registered plan accounts with more than one institution. Each institution may have its own proprietary data format, and require unique login credentials to access transaction data relating to the registered plan account(s). Therefore, there is a technical problem of being able to securely access all of the necessary underlying data, and to do so in real-time, or near real-time, in order to provide helpful data to a user. As indicated above, a technical solution may comprise obtaining authenticated access, for example via an open banking API, to initial contribution room data from the registration organization and to account contribution data from a plurality of institutions, and calculating the available contribution amount associated with each of one or more registered plan accounts.

In known approaches, there are technical limitations with respect to authenticated access and privacy considerations associated with disparate sets of data. Accordingly, known approaches are unable to properly calculate an available contribution amount for one or more registered plan accounts. A technical solution according to one or more embodiments provides improved processing efficiency and reduced resource and memory usage by effectively pre-authorizing access to a plurality of data sources, for example via an open banking API. Using that effective pre-authorization, embodiments of the present disclosure provide a technical solution of calculating available contribution amounts based on collected and consolidated data from a registration organization and one or more data servers. A data format compatible with an open banking API may be used according to embodiments of the present disclosure to provide a technical solution and provide interoperability between sets of data that are typically stored in different formats, at different organizations and in accounts requiring separate authenticated access.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for calculating contribution room for registered plan accounts. The system may include one or more hardware processors configured by machine-readable instructions. The processor(s) may be configured to obtain, from a registration organization device, initial contribution room data associated with funds eligible to be contributed into one or more registered plan accounts registered for a user with a registration organization. The processor(s) may be configured to obtain, from one or more data sources, account contribution data associated with the user's one or more registered plan accounts. The processor(s) may be configured to calculate, at a processor, an available contribution amount for the one or more registered plan accounts based on the initial contribution room data from the registration organization device and based on the account contribution data from the one or more data sources. The processor(s) may be configured to display the contribution room based on the calculated available contribution amount for the one or more registered plan accounts.

In some implementations of the system, the initial contribution room data may include an initial contribution room amount and additional contribution room parameters.

In some implementations of the system, the processor(s) may be configured to calculate, automatically and in real-time, the available contribution amount based on the initial contribution room data from the registration organization and based on the account contribution data from the one or more data sources.

In some implementations of the system, the processor(s) may be configured to calculate and display, automatically and in real-time, the available contribution room for the one or more registered plan accounts.

In some implementations of the system, the calculated available contribution amount may include a currently available contribution amount at a time associated with obtaining the initial contribution room data from the registration organization device and with obtaining the account contribution data from the one or more data sources.

In some implementations of the system, obtaining the account contribution data may further include obtaining, from a first data source, first account contribution data associated with a first registered plan account and second account contribution data associated with a second registered plan account. In some implementations of the system, the first and second registered plan accounts may be associated with the first data source and with a first institution.

In some implementations of the system, the first and second registered plan accounts may be both associated with a first type of registered plan account. In some implementations of the system, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the system, the first registered plan account may be associated with a first type of registered plan account. In some implementations of the system, the second registered plan account may be associated with a second type of registered plan account. In some implementations of the system, calculating the available contribution amount may further include calculating, at the processor, a first available contribution amount for the first type of registered plan account based on initial contribution room data from the registration organization device associated with the first type of registered plan account and based on the first account contribution data. In some implementations of the system, calculating the available contribution amount may further include calculating, at the processor, a second available contribution amount for the second type of registered plan account based on initial contribution room data from the registration organization device associated with the second type of registered plan account and based on the second account contribution data.

In some implementations of the system, obtaining the account contribution data may further include obtaining, from a first data source, first account contribution data associated with a first registered plan account and with a first institution. In some implementations of the system, obtaining the account contribution data may further include obtaining, from a second data source, second account contribution data associated with a second registered plan account and with a second institution.

In some implementations of the system, the first and second registered plan accounts may be both associated with a first type of registered plan account. In some implementations of the system, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the system, the first registered plan account may be associated with a first type of registered plan account. In some implementations of the system, the second registered plan account may be associated with a second type of registered plan account. In some implementations of the system, calculating the available contribution amount may further include calculating, at the processor, a first available contribution amount for the first type of registered plan account based on initial contribution room data from the registration organization device associated with the first type of registered plan account and based on the first account contribution data associated with the first institution. In some implementations of the system, calculating the available contribution amount may further include calculating, at the processor, a second available contribution amount for the second type of registered plan account based on initial contribution room data from the registration organization device associated with the second type of registered plan account and based on the second account contribution data associated with the second institution.

In some implementations of the system, the processor(s) may be configured to obtain the initial contribution room data from the registration organization using an open banking application programming interface. In some implementations of the system, the processor(s) may be configured to obtain the account contribution data associated with the user's one or more registered plan accounts from the one or more data sources using an open banking application programming interface.

In some implementations of the system, the open banking API may include a push API. In some implementations of the system, the processor(s) may be configured to regularly receive updates on the account contribution data via data push on the push API from the one or more data sources.

In some implementations of the system, the processor(s) may be configured to modify, automatically and in real-time, a user interface including the displayed available contribution amount based on the regularly received updates on the account contribution data from the one or more data sources.

In some implementations of the system, the open banking API may include a pull API. In some implementations of the system, the processor(s) may be configured to regularly request updates on the account contribution data via data query on the pull API to the one or more data sources.

In some implementations of the system, the initial contribution room data and the account contribution data may be both provided in an interoperable data format.

In some implementations of the system, the registration organization may be a government organization. In some implementations of the system, the one or more data sources include financial institutions. In some implementations of the system, the account contribution data may include deposit data and withdrawal data.

In some implementations of the system, the processor(s) may be configured to provide, by a first institution, an account user interface including the contribution room. In some implementations of the system, where a selected account from among the one or more registered plan accounts may be associated with the first institution.

In some implementations of the system, the processor(s) may be configured to display additional details for the selected account associated with the first institution. In some implementations of the system, the processor(s) may be configured to where correspond additional details are absent from the account user interface for registered plan accounts associated with a different institution.

In some implementations of the system, the processor(s) may be configured to provide, by a first institution, an educational registered plan user interface including the contribution room. In some implementations of the system, where a selected account from among the one or more registered plan accounts may be associated with the first institution.

In some implementations of the system, the processor(s) may be configured to display additional details for the selected account associated with the first institution. In some implementations of the system, the processor(s) may be configured to where correspond additional details are absent from the educational registered plan user interface for registered plan accounts associated with a different institution.

Another aspect of the present disclosure relates to a method for calculating contribution room for registered plan accounts. The method may include obtaining, from a registration organization device, initial contribution room data associated with funds eligible to be contributed into one or more registered plan accounts registered for a user with a registration organization. The method may include obtaining, from one or more data sources, account contribution data associated with the user's one or more registered plan accounts. The method may include calculating, at a processor, an available contribution amount for the one or more registered plan accounts based on the initial contribution room data from the registration organization device and based on the account contribution data from the one or more data sources. The method may include displaying the contribution room based on the calculated available contribution amount for the one or more registered plan accounts.

In some implementations of the method, the initial contribution room data may include an initial contribution room amount and additional contribution room parameters.

In some implementations of the method, it may include calculating, automatically and in real-time, the available contribution amount based on the initial contribution room data from the registration organization and based on the account contribution data from the one or more data sources.

In some implementations of the method, it may include calculating and displaying, automatically and in real-time, the available contribution room for the one or more registered plan accounts.

In some implementations of the method, the calculated available contribution amount may include a currently available contribution amount at a time associated with obtaining the initial contribution room data from the registration organization device and with obtaining the account contribution data from the one or more data sources.

In some implementations of the method, obtaining the account contribution data may further include obtaining, from a first data source, first account contribution data associated with a first registered plan account and second account contribution data associated with a second registered plan account. In some implementations of the method, the first and second registered plan accounts may be associated with the first data source and with a first institution.

In some implementations of the method, the first and second registered plan accounts may be both associated with a first type of registered plan account. In some implementations of the method, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the method, the first registered plan account may be associated with a first type of registered plan account. In some implementations of the method, the second registered plan account may be associated with a second type of registered plan account. In some implementations of the method, calculating the available contribution amount may further include calculating, at the processor, a first available contribution amount for the first type of registered plan account based on initial contribution room data from the registration organization device associated with the first type of registered plan account and based on the first account contribution data. In some implementations of the method, calculating the available contribution amount may further include calculating, at the processor, a second available contribution amount for the second type of registered plan account based on initial contribution room data from the registration organization device associated with the second type of registered plan account and based on the second account contribution data.

In some implementations of the method, obtaining the account contribution data may further include obtaining, from a first data source, first account contribution data associated with a first registered plan account and with a first institution. In some implementations of the method, obtaining the account contribution data may further include obtaining, from a second data source, second account contribution data associated with a second registered plan account and with a second institution.

In some implementations of the method, the first and second registered plan accounts may be both associated with a first type of registered plan account. In some implementations of the method, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the method, the first registered plan account may be associated with a first type of registered plan account. In some implementations of the method, the second registered plan account may be associated with a second type of registered plan account. In some implementations of the method, calculating the available contribution amount may further include calculating, at the processor, a first available contribution amount for the first type of registered plan account based on initial contribution room data from the registration organization device associated with the first type of registered plan account and based on the first account contribution data associated with the first institution. In some implementations of the method, calculating the available contribution amount may further include calculating, at the processor, a second available contribution amount for the second type of registered plan account based on initial contribution room data from the registration organization device associated with the second type of registered plan account and based on the second account contribution data associated with the second institution.

In some implementations of the method, it may include obtaining the initial contribution room data from the registration organization using an open banking application programming interface. In some implementations of the method, it may include obtaining the account contribution data associated with the user's one or more registered plan accounts from the one or more data sources using an open banking application programming interface.

In some implementations of the method, the open banking API may include a push API. In some implementations of the method, it may include regularly receiving updates on the account contribution data via data push on the push API from the one or more data sources.

In some implementations of the method, it may include modifying, automatically and in real-time, a user interface including the displayed available contribution amount based on the regularly received updates on the account contribution data from the one or more data sources.

In some implementations of the method, the open banking API may include a pull API. In some implementations of the method, it may include regularly requesting updates on the account contribution data via data query on the pull API to the one or more data sources.

In some implementations of the method, the initial contribution room data and the account contribution data may be both provided in an interoperable data format.

In some implementations of the method, the registration organization may be a government organization. In some implementations of the method, the one or more data sources include financial institutions. In some implementations of the method, the account contribution data may include deposit data and withdrawal data.

In some implementations of the method, it may include providing, by a first institution, an account user interface including the contribution room. In some implementations of the method, where a selected account from among the one or more registered plan accounts may be associated with the first institution.

In some implementations of the method, it may include displaying additional details for the selected account associated with the first institution. In some implementations of the method, it may include where corresponding additional details are absent from the account user interface for registered plan accounts associated with a different institution.

In some implementations of the method, it may include providing, by a first institution, an educational registered plan user interface including the contribution room. In some implementations of the method, where a selected account from among the one or more registered plan accounts may be associated with the first institution.

In some implementations of the method, it may include displaying additional details for the selected account associated with the first institution. In some implementations of the method, it may include where corresponding additional details are absent from the educational registered plan user interface for registered plan accounts associated with a different institution.

Yet another aspect of the present disclosure relates to a non-transient computer-readable storage medium having instructions embodied thereon, the instructions being executable by one or more processors to perform a method for calculating contribution room for registered plan accounts. The method may include obtaining, from a registration organization device, initial contribution room data associated with funds eligible to be contributed into one or more registered plan accounts registered for a user with a registration organization. The method may include obtaining, from one or more data sources, account contribution data associated with the user's one or more registered plan accounts. The method may include calculating, at a processor, an available contribution amount for the one or more registered plan accounts based on the initial contribution room data from the registration organization device and based on the account contribution data from the one or more data sources. The method may include displaying the contribution room based on the calculated available contribution amount for the one or more registered plan accounts.

In some implementations of the computer-readable storage medium, the initial contribution room data may include an initial contribution room amount and additional contribution room parameters.

In some implementations of the computer-readable storage medium, the method may include calculating, automatically and in real-time, the available contribution amount based on the initial contribution room data from the registration organization and based on the account contribution data from the one or more data sources.

In some implementations of the computer-readable storage medium, the method may include calculating and displaying, automatically and in real-time, the available contribution room for the one or more registered plan accounts.

In some implementations of the computer-readable storage medium, the calculated available contribution amount may include a currently available contribution amount at a time associated with obtaining the initial contribution room data from the registration organization device and with obtaining the account contribution data from the one or more data sources.

In some implementations of the computer-readable storage medium, obtaining the account contribution data may further include obtaining, from a first data source, first account contribution data associated with a first registered plan account and second account contribution data associated with a second registered plan account. In some implementations of the computer-readable storage medium, the first and second registered plan accounts may be associated with the first data source and with a first institution.

In some implementations of the computer-readable storage medium, the first and second registered plan accounts may be both associated with a first type of registered plan account. In some implementations of the computer-readable storage medium, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the computer-readable storage medium, the first registered plan account may be associated with a first type of registered plan account. In some implementations of the computer-readable storage medium, the second registered plan account may be associated with a second type of registered plan account. In some implementations of the computer-readable storage medium, calculating the available contribution amount may further include calculating, at the processor, a first available contribution amount for the first type of registered plan account based on initial contribution room data from the registration organization device associated with the first type of registered plan account and based on the first account contribution data. In some implementations of the computer-readable storage medium, calculating the available contribution amount may further include calculating, at the processor, a second available contribution amount for the second type of registered plan account based on initial contribution room data from the registration organization device associated with the second type of registered plan account and based on the second account contribution data.

In some implementations of the computer-readable storage medium, obtaining the account contribution data may further include obtaining, from a first data source, first account contribution data associated with a first registered plan account and with a first institution. In some implementations of the computer-readable storage medium, obtaining the account contribution data may further include obtaining, from a second data source, second account contribution data associated with a second registered plan account and with a second institution.

In some implementations of the computer-readable storage medium, the first and second registered plan accounts may be both associated with a first type of registered plan account. In some implementations of the computer-readable storage medium, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the computer-readable storage medium, the first registered plan account may be associated with a first type of registered plan account. In some implementations of the computer-readable storage medium, the second registered plan account may be associated with a second type of registered plan account. In some implementations of the computer-readable storage medium, calculating the available contribution amount may further include calculating, at the processor, a first available contribution amount for the first type of registered plan account based on initial contribution room data from the registration organization device associated with the first type of registered plan account and based on the first account contribution data associated with the first institution. In some implementations of the computer-readable storage medium, calculating the available contribution amount may further include calculating, at the processor, a second available contribution amount for the second type of registered plan account based on initial contribution room data from the registration organization device associated with the second type of registered plan account and based on the second account contribution data associated with the second institution.

In some implementations of the computer-readable storage medium, the method may include obtaining the initial contribution room data from the registration organization using an open banking application programming interface. In some implementations of the computer-readable storage medium, the method may include obtaining the account contribution data associated with the user's one or more registered plan accounts from the one or more data sources using an open banking application programming interface.

In some implementations of the computer-readable storage medium, the open banking API may include a push API. In some implementations of the computer-readable storage medium, the method may include regularly receiving updates on the account contribution data via data push on the push API from the one or more data sources.

In some implementations of the computer-readable storage medium, the method may include modifying, automatically and in real-time, a user interface including the displayed available contribution amount based on the regularly received updates on the account contribution data from the one or more data sources.

In some implementations of the computer-readable storage medium, the open banking API may include a pull API. In some implementations of the computer-readable storage medium, the method may include regularly requesting updates on the account contribution data via data query on the pull API to the one or more data sources.

In Ir some implementations of the computer-readable storage medium, the initial contribution room data and the account contribution data may be both provided in an interoperable data format.

In some implementations of the computer-readable storage medium, the registration organization may be a government organization. In some implementations of the computer-readable storage medium, the one or more data sources include financial institutions. In some implementations of the computer-readable storage medium, the account contribution data may include deposit data and withdrawal data.

In some implementations of the computer-readable storage medium, the method may include providing, by a first institution, an account user interface including the contribution room. In some implementations of the computer-readable storage medium, where a selected account from among the one or more registered plan accounts may be associated with the first institution.

In some implementations of the computer-readable storage medium, the method may include displaying additional details for the selected account associated with the first institution. In some implementations of the computer-readable storage medium, the method may include where corresponding additional details are absent from the account user interface for registered plan accounts associated with a different institution.

In some implementations of the computer-readable storage medium, the method may include providing, by a first institution, an educational registered plan user interface including the contribution room. In some implementations of the computer-readable storage medium, where a selected account from among the one or more registered plan accounts may be associated with the first institution.

In some implementations of the computer-readable storage medium, the method may include displaying additional details for the selected account associated with the first institution. In some implementations of the computer-readable storage medium, the method may include where corresponding additional details are absent from the educational registered plan user interface for registered plan accounts associated with a different institution.

Still another aspect of the present disclosure relates to a system configured for calculating contribution room for registered plan accounts. The system may include means for obtaining, from a registration organization device, initial contribution room data associated with funds eligible to be contributed into one or more registered plan accounts registered for a user with a registration organization. The system may include means for obtaining, from one or more data sources, account contribution data associated with the user's one or more registered plan accounts. The system may include means for calculating, at a processor, an available contribution amount for the one or more registered plan accounts based on the initial contribution room data from the registration organization device and based on the account contribution data from the one or more data sources. The system may include means for displaying the contribution room based on the calculated available contribution amount for the one or more registered plan accounts.

In some implementations of the system, the initial contribution room data may include an initial contribution room amount and additional contribution room parameters.

In some implementations of the system, the system may include means for calculating, automatically and in real-time, the available contribution amount based on the initial contribution room data from the registration organization and based on the account contribution data from the one or more data sources.

In some implementations of the system, the system may include means for calculating and displaying, automatically and in real-time, the available contribution room for the one or more registered plan accounts.

In some implementations of the system, the calculated available contribution amount may include a currently available contribution amount at a time associated with obtaining the initial contribution room data from the registration organization device and with obtaining the account contribution data from the one or more data sources.

In some implementations of the system, obtaining the account contribution data may further include obtaining, from a first data source, first account contribution data associated with a first registered plan account and second account contribution data associated with a second registered plan account. In some implementations of the system, the first and second registered plan accounts may be associated with the first data source and with a first institution.

In some implementations of the system, the first and second registered plan accounts may be both associated with a first type of registered plan account. In some implementations of the system, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the system, the first registered plan account may be associated with a first type of registered plan account. In some implementations of the system, the second registered plan account may be associated with a second type of registered plan account. In some implementations of the system, calculating the available contribution amount may further include calculating, at the processor, a first available contribution amount for the first type of registered plan account based on initial contribution room data from the registration organization device associated with the first type of registered plan account and based on the first account contribution data. In some implementations of the system, calculating the available contribution amount may further include calculating, at the processor, a second available contribution amount for the second type of registered plan account based on initial contribution room data from the registration organization device associated with the second type of registered plan account and based on the second account contribution data.

In some implementations of the system, obtaining the account contribution data may further include obtaining, from a first data source, first account contribution data associated with a first registered plan account and with a first institution. In some implementations of the system, obtaining the account contribution data may further include obtaining, from a second data source, second account contribution data associated with a second registered plan account and with a second institution.

In some implementations of the system, the first and second registered plan accounts may be both associated with a first type of registered plan account. In some implementations of the system, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the system, the first registered plan account may be associated with a first type of registered plan account. In some implementations of the system, the second registered plan account may be associated with a second type of registered plan account. In some implementations of the system, calculating the available contribution amount may further include calculating, at the processor, a first available contribution amount for the first type of registered plan account based on initial contribution room data from the registration organization device associated with the first type of registered plan account and based on the first account contribution data associated with the first institution. In some implementations of the system, calculating the available contribution amount may further include calculating, at the processor, a second available contribution amount for the second type of registered plan account based on initial contribution room data from the registration organization device associated with the second type of registered plan account and based on the second account contribution data associated with the second institution.

In some implementations of the system, the system may include means for obtaining the initial contribution room data from the registration organization using an open banking application programming interface. In some implementations of the system, the system may include means for obtaining the account contribution data associated with the user's one or more registered plan accounts from the one or more data sources using an open banking application programming interface.

In some implementations of the system, the open banking API may include a push API. In some implementations of the system, the system may include means for regularly receiving updates on the account contribution data via data push on the push API from the one or more data sources.

In some implementations of the system, the system may include means for modifying, automatically and in real-time, a user interface including the displayed available contribution amount based on the regularly received updates on the account contribution data from the one or more data sources.

In some implementations of the system, the open banking API may include a pull API. In some implementations of the system, the system may include means for regularly requesting updates on the account contribution data via data query on the pull API to the one or more data sources.

In some implementations of the system, the initial contribution room data and the account contribution data may be both provided in an interoperable data format.

In some implementations of the system, the registration organization may be a government organization. In some implementations of the system, the one or more data sources include financial institutions. In some implementations of the system, the account contribution data may include deposit data and withdrawal data.

In some implementations of the system, the system may include means for providing, by a first institution, an account user interface including the contribution room. In some implementations of the system, where a selected account from among the one or more registered plan accounts may be associated with the first institution.

In some implementations of the system, the system may include means for displaying additional details for the selected account associated with the first institution. In some implementations of the system, the system may include means for where corresponding additional details are absent from the account user interface for registered plan accounts associated with a different institution.

In some implementations of the system, the system may include means for providing, by a first institution, an educational registered plan user interface including the contribution room. In some implementations of the system, where a selected account from among the one or more registered plan accounts may be associated with the first institution.

In some implementations of the system, the system may include means for displaying additional details for the selected account associated with the first institution. In some implementations of the system, the system may include means for where corresponding additional details are absent from the educational registered plan user interface for registered plan accounts associated with a different institution.

Even another aspect of the present disclosure relates to a computing platform configured for calculating contribution room for registered plan accounts. The computing platform may include a non-transient computer-readable storage medium having executable instructions embodied thereon. The computing platform may include one or more hardware processors configured to execute the instructions. The processor(s) may execute the instructions to obtain, from a registration organization device, initial contribution room data associated with funds eligible to be contributed into one or more registered plan accounts registered for a user with a registration organization. The processor(s) may execute the instructions to obtain, from one or more data sources, account contribution data associated with the user's one or more registered plan accounts. The processor(s) may execute the instructions to calculate, at a processor, an available contribution amount for the one or more registered plan accounts based on the initial contribution room data from the registration organization device and based on the account contribution data from the one or more data sources. The processor(s) may execute the instructions to display the contribution room based on the calculated available contribution amount for the one or more registered plan accounts.

In some implementations of the computing platform, the initial contribution room data may include an initial contribution room amount and additional contribution room parameters.

In some implementations of the computing platform, the processor(s) may execute the instructions to calculate, automatically and in real-time, the available contribution amount based on the initial contribution room data from the registration organization and based on the account contribution data from the one or more data sources.

In some implementations of the computing platform, the processor(s) may execute the instructions to calculate and display, automatically and in real-time, the available contribution room for the one or more registered plan accounts.

In some implementations of the computing platform, the calculated available contribution amount may include a currently available contribution amount at a time associated with obtaining the initial contribution room data from the registration organization device and with obtaining the account contribution data from the one or more data sources.

In some implementations of the computing platform, obtaining the account contribution data may further include obtaining, from a first data source, first account contribution data associated with a first registered plan account and second account contribution data associated with a second registered plan account. In some implementations of the computing platform, the first and second registered plan accounts may be associated with the first data source and with a first institution.

In some implementations of the computing platform, the first and second registered plan accounts may be both associated with a first type of registered plan account. In some implementations of the computing platform, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the computing platform, the first registered plan account may be associated with a first type of registered plan account. In some implementations of the computing platform, the second registered plan account may be associated with a second type of registered plan account. In some implementations of the computing platform, calculating the available contribution amount may further include calculating, at the processor, a first available contribution amount for the first type of registered plan account based on initial contribution room data from the registration organization device associated with the first type of registered plan account and based on the first account contribution data. In some implementations of the computing platform, calculating the available contribution amount may further include calculating, at the processor, a second available contribution amount for the second type of registered plan account based on initial contribution room data from the registration organization device associated with the second type of registered plan account and based on the second account contribution data.

In some implementations of the computing platform, obtaining the account contribution data may further include obtaining, from a first data source, first account contribution data associated with a first registered plan account and with a first institution. In some implementations of the computing platform, obtaining the account contribution data may further include obtaining, from a second data source, second account contribution data associated with a second registered plan account and with a second institution.

In some implementations of the computing platform, the first and second registered plan accounts may be both associated with a first type of registered plan account. In some implementations of the computing platform, calculating the available contribution amount may further include calculating, at the processor, a first available contribution amount for the first type of registered plan account based on initial contribution room data from the registration organization device associated with the first type of registered plan account and based on the first account contribution data and on the second account contribution data.

In some implementations of the computing platform, the first registered plan account may be associated with a first type of registered plan account. In some implementations of the computing platform, the second registered plan account may be associated with a second type of registered plan account. In some implementations of the computing platform, calculating the available contribution amount may further include calculating, at the processor, a first available contribution amount for the first type of registered plan account based on initial contribution room data from the registration organization device associated with the first type of registered plan account and based on the first account contribution data associated with the first institution. In some implementations of the computing platform, calculating the available contribution amount may further include calculating, at the processor, a second available contribution amount for the second type of registered plan account based on initial contribution room data from the registration organization device associated with the second type of registered plan account and based on the second account contribution data associated with the second institution.

In some implementations of the computing platform, the processor(s) may execute the instructions to obtain the initial contribution room data from the registration organization using an open banking application programming interface. In some implementations of the computing platform, the processor(s) may execute the instructions to obtain the account contribution data associated with the user's one or more registered plan accounts from the one or more data sources using an open banking application programming interface.

In some implementations of the computing platform, the open banking API may include a push API. In some implementations of the computing platform, the processor(s) may execute the instructions to regularly receive updates on the account contribution data via data push on the push API from the one or more data sources.

In some implementations of the computing platform, the processor(s) may execute the instructions to modify, automatically and in real-time, a user interface including the displayed available contribution amount based on the regularly received updates on the account contribution data from the one or more data sources.

In some implementations of the computing platform, the open banking API may include a pull API. In some implementations of the computing platform, the processor(s) may execute the instructions to regularly request updates on the account contribution data via data query on the pull API to the one or more data sources.

In some implementations of the computing platform, the initial contribution room data and the account contribution data may be both provided in an interoperable data format.

In some implementations of the computing platform, the registration organization may be a government organization. In some implementations of the computing platform, the one or more data sources include financial institutions. In some implementations of the computing platform, the account contribution data may include deposit data and withdrawal data.

In some implementations of the computing platform, the processor(s) may execute the instructions to provide, by a first institution, an account user interface including the contribution room. In some implementations of the computing platform, where a selected account from among the one or more registered plan accounts may be associated with the first institution.

In some implementations of the computing platform, the processor(s) may execute the instructions to display additional details for the selected account associated with the first institution. In some implementations of the computing platform, the processor(s) may execute the instructions to where correspond additional details are absent from the account user interface for registered plan accounts associated with a different institution.

In some implementations of the computing platform, the processor(s) may execute the instructions to provide, by a first institution, an educational registered plan user interface including the contribution room. In some implementations of the computing platform, where a selected account from among the one or more registered plan accounts may be associated with the first institution.

In some implementations of the computing platform, the processor(s) may execute the instructions to display additional details for the selected account associated with the first institution. In some implementations of the computing platform, the processor(s) may execute the instructions to where correspond additional details are absent from the educational registered plan user interface for registered plan accounts associated with a different institution.

What is claimed is:

1. An apparatus configured for calculating available contribution room for registered plan accounts, the apparatus comprising:
a non-transient computer-readable storage medium having executable instructions embodied thereon; and
one or more hardware processors configured to execute the instructions to:
obtain, from a registration organization device, initial contribution room data associated with funds eligible to be contributed into one or more registered plan accounts registered for a user with a registration organization;
obtain, from one or more data sources, account contribution data associated with the user's one or more registered plan accounts;
calculate, at a processor, an available contribution amount for the one or more registered plan accounts based on the initial contribution room data from the registration organization device and based on the account contribution data from the one or more data sources; and
display the contribution room based on the calculated available contribution amount for the one or more registered plan accounts.

2. The apparatus of claim 1 wherein the one or more hardware processors are further configured to execute the instructions to:
calculate, automatically and in real-time, the available contribution amount based on the initial contribution room data from the registration organization and based on the account contribution data from the one or more data sources.

3. The apparatus of claim 1 wherein the one or more hardware processors are further configured to execute the instructions to:
provide, by a first institution, an educational registered plan user interface comprising the contribution room, where a selected account from among the one or more registered plan accounts is associated with the first institution.

4. The apparatus of claim 1 wherein the one or more hardware processors are further configured to execute the instructions to:
obtain, from a first data source, first account contribution data associated with a first registered plan account and second account contribution data associated with a second registered plan account, the first and second registered plan accounts being associated with the first data source and with a first institution.

5. The apparatus of claim 1 wherein the first and second registered plan accounts are both associated with a first type of registered plan account, and wherein the one or more hardware processors are further configured to execute the instructions to:
calculate, at the one or more hardware processors, a first available contribution amount for the first type of registered plan account based on initial contribution room data from the registration organization device associated with the first type of registered plan account and based on the first account contribution data and on the second account contribution data.

6. The apparatus of claim 1 wherein the one or more hardware processors are further configured to execute the instructions to:
obtain, from a first data source, first account data associated with a first registered plan account and with a first institution; and
obtain, from a second data source, second account data associated with a second registered plan account and with a second institution.

7. The apparatus of claim 1 wherein the first and second registered plan accounts are both associated with a second type of registered plan account, and wherein the one or more hardware processors are further configured to execute the instructions to:
calculate, at the one or more hardware processors, a first available contribution amount for the first type of registered plan account based on initial contribution room data from the registration organization device associated with the first type of registered plan account and based on the first account contribution data and on the second account contribution data.

8. The apparatus of claim 1 wherein the one or more hardware processors are further configured to execute the instructions to:
obtain the initial contribution room data from the registration organization using an open banking application programming interface (API); and
obtain the account contribution data associated with the user's one or more registered plan accounts from the one or more data sources using an open banking application programming interface (API).

9. The apparatus of claim 8 wherein the open banking API comprises a push API, and wherein the one or more hardware processors are further configured to execute the instructions to:
regularly receive updates on the account contribution data via data push on the push API from the one or more data sources.

10. A computer-implemented method of calculating available contribution room for registered plan accounts, the method comprising:
obtaining, from a registration organization device, initial contribution room data associated with funds eligible to be contributed into one or more registered plan accounts registered for a user with a registration organization;
obtaining, from one or more data sources, account contribution data associated with the user's one or more registered plan accounts;
calculating, at a processor, an available contribution amount for the one or more registered plan accounts based on the initial contribution room data from the registration organization device and based on the account contribution data from the one or more data sources; and
displaying the contribution room based on the calculated available contribution amount for the one or more registered plan accounts.

11. The method of claim 10 further comprising:
calculating, automatically and in real-time, the available contribution amount based on the initial contribution room data from the registration organization and based on the account contribution data from the one or more data sources.

12. The method of claim 10 further comprising:
providing, by a first institution, an educational registered plan user interface comprising the contribution room, where a selected account from among the one or more registered plan accounts is associated with the first institution.

13. The method of claim 10 wherein obtaining the account data further comprises:
obtaining, from a first data source, first account contribution data associated with a first registered plan account and second account contribution data associated with a second registered plan account, the first and second registered plan accounts being associated with the first data source and with a first institution.

14. The method of claim 13 wherein the first and second registered plan accounts are both associated with a first type of registered plan account, and calculating the available contribution room further comprises:
calculating, at the processor, a first available contribution amount for the first type of registered plan account based on initial contribution room data from the registration organization device associated with the first type of registered plan account and based on the first account contribution data and on the second account contribution data.

15. The method of claim 1 wherein obtaining the account data further comprises:
obtaining, from a first data source, first account data associated with a first registered plan account and with a first institution; and
obtaining, from a second data source, second account data associated with a second registered plan account and with a second institution.

16. The method of claim 15 wherein the first and second registered plan accounts are both associated with a second type of registered plan account, and calculating the available contribution room further comprises:
calculating, at the processor, a first available contribution amount for the first type of registered plan account based on initial contribution room data from the registration organization device associated with the first type of registered plan account and based on the first account contribution data and on the second account contribution data.

17. The method of claim 1 further comprising:
obtaining the initial contribution room data from the registration organization using an open banking application programming interface (API); and
obtaining the account contribution data associated with the user's one or more registered plan accounts from the one or more data sources using an open banking application programming interface (API).

18. The method of claim 17 wherein the open banking API comprises a push API, and wherein the method further comprises:
regularly receiving updates on the account contribution data via data push on the push API from the one or more data sources.

19. A non-transient computer-readable storage medium having instructions embodied thereon, the instructions being executable by one or more processors to perform a method for providing multi-channel authentication, the method comprising:
obtaining, from a registration organization device, initial contribution room data associated with funds eligible to be contributed into one or more registered plan accounts registered for a user with a registration organization;
obtaining, from one or more data sources, account contribution data associated with the user's one or more registered plan accounts;
calculating, at a processor, an available contribution amount for the one or more registered plan accounts based on the initial contribution room data from the registration organization device and based on the account contribution data from the one or more data sources; and
displaying the contribution room based on the calculated available contribution amount for the one or more registered plan accounts.

20. The non-transient computer-readable storage medium of claim 19 wherein the method further comprises:
calculating, automatically and in real-time, the available contribution amount based on the initial contribution room data from the registration organization and based on the account contribution data from the one or more data sources.
